(19) United States
(12) Patent Application Publication
(10) Pub. No.: US 2003/0023951 A1
(43) Pub. Date: Jan. 30, 2003

(54) MATLAB toolbox for advanced statistical modeling and data analysis

(76) Inventor: Philip S. Rosenberg, Bethesda, MD (US)

Correspondence Address: Mary L. Miller, Esq., NEEDLE & ROSENBERG, P.C., Suite 1200, The Candler Building, 127 Peachtree Street, N.E., Atlanta, GA, 30303-1811, US

(21) Appl. No.: 09/827,138

(22) Filed: Apr. 5, 2001

(51) Int. Cl. G06F 9/44

(52) U.S. Cl. 717/104

(57) ABSTRACT

A toolbox and method for processing data statistically in a MATLAB® environment of a computer. The method includes the steps of embedding input data and associated meta-data in a single object, and constructing the input data and associated meta-data into a plurality of statistical variables, wherein the plurality of statistical variables can be processed statistically. The method further includes a step of creating a contingency table from the plurality of statistical variables. In one embodiment of the present invention, the step of creating a contingency table from the plurality of statistical variables includes a step of creating the contingency table using the hypertext markup language, wherein the contingency table created by using the hypertext markup language is generated on a web page. Additionally, the method further includes a step of aggregating a dataset from the plurality of statistical variables. In one embodiment of the invention, the step of aggregating a dataset from the plurality of statistical variables includes the steps of providing a plurality of objects with same length, each object having a set of statistical variables, providing meta-data associated with the plurality of objects, and constructing a dataset from the plurality of objects and the associated meta-data, wherein all statistical variables in the dataset can be statistically processed at once using standard MATLAB® syntax. The method further includes the steps of providing a statistical model with control parameters, providing input data, constructing the input data and the control parameters into a single object, and processing the input data in the single object to produce an output according to the model. In one embodiment of the present invention, the input data and control parameters are adjustable. When the input data or control parameters are adjusted, the output is changed accordingly. The method also includes a step of viewing and documenting the changes in the output interactively through a MATLAB® based graphical interface. Moreover, adjusting the input data and/or control parameters can be performed interactively through a MATLAB® based graphical interface.

### BACKGROUND OF THE INVENTION

1. Field of the Invention

The present invention generally relates to a program implemented on a computer system. More particularly, the present invention relates to a program or toolbox for advanced statistical modeling and data analysis in a MATLAB® environment of a computer system.

2. Description of the Related Art

Data processing has become increasingly important. Also, data processing has become part of almost every work environment. Moreover, the amount of data collected and the complexity of the desired analyses of that collected data are continuously growing. Accordingly, the tools for such analyses have become highly specialized, normally requiring considerable knowledge of the operational details, search languages, statistical modeling and mathematical theory. As a result, the available tools are difficult to use and provide rather limited functionality. Historically, only highly trained individuals had the skill to use analysis including statistical modeling and visualization software tools.

One of such analysis and visualization software tools is MATLAB®. MATLAB® is a premiere technical computing environment that is developed by MathWorks, Inc., Natick, Mass., and is widely used by scientists and engineers to solve mathematical problems arising in diverse scientific and engineering disciplines, and for prototyping and rapid development of technical applications. MATLAB® is a high-level interpreted matrix language as described, for example, in MATLAB® 6 User's Guide which can be found and downloaded at http://www.mathworks.com.

The core environment of MATLAB® can be extended by means of “toolboxes.” Each toolbox is a program and contains a collection of functions that pertain to specific application areas. MATLAB® also includes a facility for object oriented programming. This facility allows a developer or user to extend the MATLAB® language by creating new classes of objects, or data types, that can be manipulated using defined methods, or rules. These new objects adhere to established and accepted principles of object oriented programming, including encapsulation, polymorphism, overloading, inheritance, and aggregation, as known to those skilled in the art. Because MATLAB® objects adhere to these principles, a developer or user can more rapidly build new applications that are feature-rich, reliable, and easy to use effectively.

One of the toolboxes developed for MATLAB® is a Statistics Toolbox. The Statistics Toolbox provides many fundamental statistical algorithms, including probability distribution functions and statistical tests of hypotheses. Indeed, MATLAB®, in combination with the Statistics Toolbox and other numerically oriented toolboxes, can provide a powerful and comprehensive environment for carrying out the mathematical calculations that are the underpinnings of modem statistical analysis.

Thus, MATLAB® has the potential to become a powerful tool for statistical research, development, and applications. However, the realization of this potential has been limited by the lack of essential facilities for statistically processing data including manipulating statistical data, presenting statistical summaries in a coherent manner, and presenting numeric and graphic summaries of statistical models in a MATLAB® environment. Consequently, it is difficult to process statistical data and/or draw statistical inferences and conclusions entirely within the MATLAB® environment. It becomes more evident for processing large-scale projects in which the number of objects and the number of data elements in each object both are large that there is no sufficient statistical capability currently in a MATLAB® environment.

Therefore, there exists a need to enhance statistical capabilities in a MATLAB® environment. In particular, there is a need to develop a new toolbox to enhance statistical capabilities using object-oriented principles in a MATLAB® environment.

### SUMMARY OF THE INVENTION

In one aspect, the present invention provides a method for processing data in a MATLAB® environment of a computer. The method includes the steps of embedding input data and associated meta-data in a single object, and constructing the input data and associated meta-data into a plurality of statistical variables, wherein the plurality of statistical variables can be processed statistically.

The method further includes a step of creating a contingency table from the plurality of statistical variables. In one embodiment of the present invention, the step of creating a contingency table from the plurality of statistical variables includes a step of creating a representation of the contingency table using the hypertext markup language, wherein the contingency table created by using the hypertext markup language is generated on a web page.

Additionally, the method further includes a step of aggregating a dataset from the plurality of statistical variables. In one embodiment of the invention, the step of aggregating a dataset from the plurality of statistical variables includes the steps of providing a plurality of objects with the same length, each object having a set of statistical variables, providing meta-data associated with the plurality of objects, and constructing a dataset from the plurality of objects and the associated meta-data, wherein all statistical variables in the dataset can be statistically processed at once using standard MATLAB® syntax.

In another aspect, the present invention provides a method for processing data in a MATLAB® environment of a computer. The method includes the steps of providing a statistical model with control parameters, providing input data, constructing the input data and the control parameters into a single object, and processing the input data in the single object to produce an output according to the model.

In one embodiment of the present invention, the input data are adjustable. When the input data are adjusted, the output is changed accordingly. The method also includes a step of viewing and documenting the changes in the output interactively through a MATLAB® based graphical interface. Moreover, adjusting the input data can be performed interactively through a MATLAB® based graphical interface.

In another embodiment of the present invention, the control parameters are adjustable. When the control parameters are adjusted, the output is changed accordingly. The method also includes a step of adjusting control parameters interactively through a MATLAB® based graphical interface.

The present invention further includes a computer program product in a computer readable medium of instructions. The computer program product has instructions within the computer readable medium for embedding input data and associated meta-data in a single object, and instructions within the computer readable medium for constructing the input data and associated meta-data into a plurality of statistical variables, wherein the plurality of statistical variables can be processed statistically. Additionally, the computer program product has the instructions within the computer readable medium for generating the plurality of statistical variables including continuous variables, categorical variables, rates, proportions, compound data, B-spline data, censored survival data, data from a Poisson process, binary response data, logical data, and text data. Moreover, the computer program product of the present invention has instructions within the computer readable medium for producing a new statistical variable by a product of at least two of the plurality of statistical variables.

Additionally, the computer program product has instructions within the computer readable medium for creating a contingency table from the plurality of statistical variables. Furthermore, the computer program product has the instructions within the computer readable medium for creating a contingency table from the plurality of statistical variables written in the hypertext markup language, wherein the contingency table can be generated on a web page.

Moreover, the computer program product has instructions within the computer readable medium for aggregating a dataset from the plurality of statistical variables and instructions within the computer readable medium for processing all statistical variables in the dataset at once using standard MATLAB® syntax.

In yet another aspect, the present invention includes a computer program product in a computer readable medium of instructions for processing data in a MATLAB® environment of a computer. The computer program product has instructions within the computer readable medium for providing a statistical model with control parameters, instructions within the computer readable medium for receiving and providing input data, instructions within the computer readable medium for constructing the input data and the control parameters into a single object, and instructions within the computer readable medium for processing the input data in the single object to produce an output according to the model.

In one embodiment of the present invention, the computer program product has instructions within the computer readable medium for adjusting the input data, wherein when the input data are adjusted, the output is changed accordingly. Moreover, the computer program product has instructions within the computer readable medium for viewing and documenting the changes in the output interactively through a MATLAB® based graphical interface. Additionally, the computer program product has instructions within the computer readable medium interactively through a MATLAB®based graphical interface.

In another embodiment of the present invention, the computer program product has instructions within the computer readable medium for adjusting control parameters, wherein when the control parameters are adjusted, the output is changed accordingly. Moreover, the computer program product has instructions within the computer readable medium for adjusting control parameters interactively through a MATLAB® based graphical interface.

In a further aspect, the present invention relates to a system for managing data in a MATLAB® environment of a computer. The system has a processing means for embedding input data and associated meta-data in a single object, and an operating means for constructing the input data and associated meta-data into a plurality of statistical variables, wherein the plurality of statistical variables can be processed statistically. In one embodiment of the present invention, the processing means can be a host processor associated with the computer, and the operating means can be an operating system resident in a memory of the computer.

In yet another aspect, the present invention relates to a system for managing data in a MATLAB® environment of a computer. The system has means for providing a statistical model with control parameters, means for providing input data, means for constructing the input data and the control parameters into a single object, and means for processing the input data in the single object to produce an output according to the model. In one embodiment of the present invention, where the input data are adjustable, and the system has means for changing the output accordingly when the input data are adjusted. Moreover, the system further includes means for viewing and documenting the changes in the output interactively through a MATLAB® based graphical interface, and means for adjusting the input data interactively through a MATLAB® based graphical interface. In another embodiment of the present invention, where the control parameters are adjustable, and the system has means for changing the output accordingly when the set of control parameters are adjusted. Moreover, the system further has means for adjusting the control parameters interactively through a MATLAB® based graphical interface.

In one embodiment of the present invention, the plurality of statistical variables include continuous variables, categorical variables, rates, proportions, compound data, B-spline data, censored survival data, data from a Poisson process, binary response data, logical data, and longitudinal data. These statistical variables form a coherent structure. A product of at least two of the plurality of statistical variables can produce a new statistical variable.

In another embodiment of the present invention, a contingency table can be created from the plurality of statistical variables. The contingency table can be a multi-way contingency table such as a two-way contingency table or a three-way contingency table. The contingency table can be represented in the hypertext markup language and can be generated on a web page.

In yet another embodiment of the present invention, a dataset can be aggregated from the plurality of statistical variables. In doing so, a plurality of objects with same length, each object having a set of statistical variables, are provided. Also provided are meta-data associated with the plurality of objects. A dataset is constructed from the plurality of objects and the associated meta-data, wherein all statistical variables in the dataset can be statistically processed at once using standard MATLAB® syntax.

In a further embodiment of the present invention, the statistical model can be a regression model. The regression model can include a generalized linear model, a generalized additive model, a proportional hazards regression model, or a smoother. Additionally, the statistical model can also be a model for censored survival data. The model for censored survival data can include a regression model, a generalized linear (Cox) model, a local likelihood model, lifetable methods, or hazard spline regression.

These and other aspects will become apparent from the following description of the preferred embodiment taken in conjunction with the following drawings, although variations and modifications may be effected without departing from the spirit and scope of the novel concepts of the disclosure.

### BRIEF DESCRIPTION OF THE DRAWINGS

FIG. 1 is a perspective view of a computer where a MATLAB® environment can be hosted and the invention can be practiced.

FIG. 2 is a flow chart describing a method employed in one embodiment of the invention.

FIG. 3 illustrates a structure of statistical variables defined by using MATLAB® object-oriented programming facility in one embodiment of the invention.

FIG. 4 illustrates a process of analyzing data statistically by using statistical variables and standard MATLAB® command syntax in one embodiment of the invention.

FIG. 5(A) is a flow chart describing a method providing a two-way contingency table employed in one embodiment of the invention; and (B) is a flow chart describing a method providing a three-way contingency table employed in one embodiment of the invention.

FIGS. 6 (A)-(B) show a two-way contingency table created on a web page in one embodiment of the invention.

FIG. 7 illustrates a process of aggregating a dataset in one embodiment of the invention.

FIG. 8 is a flow chart describing a general paradigm of implementing a statistical model in one embodiment of the invention.

FIG. 9 is a flow chart describing a process of updating outcome of a statistical model in one embodiment of the invention: (A) when input data are changed; and (B) when control parameters are changed.

FIG. 10 illustrates classes of regression models employed in one embodiment of the invention.

FIG. 11 illustrates classes of censored survival data models employed in one embodiment of the invention.

### DETAILED DESCRIPTION OF THE INVENTION

A preferred embodiment of the invention is now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

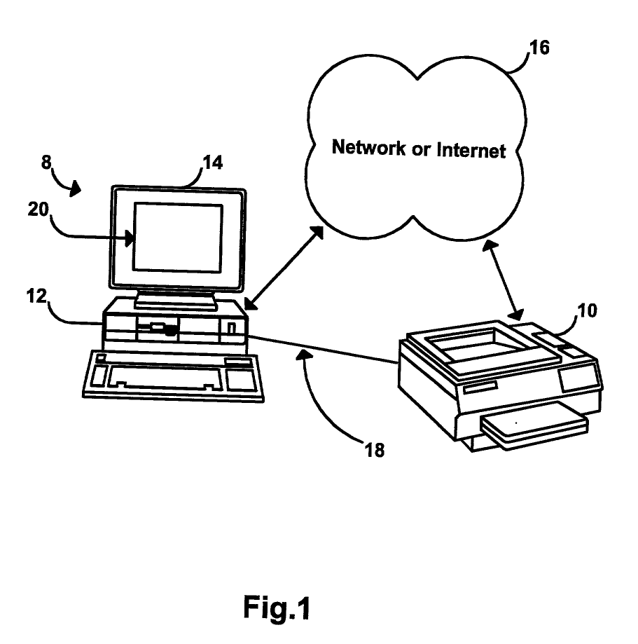

With reference to FIG. 1, there is shown a perspective view of a host computer 8 having a host processor 12 with a display 14, such as a monitor, having a graphic-user interface (GUI) 20 displaying data. At least one peripheral device 10, shown here as a printer, is in operative communication with the host processor 12. The printer 10 and host processor 12 can be in communication through any media, such as a direct wire connection 18 or through a network or the Internet 16. Additionally, host processor can communicate to other computers (not shown) in a LAN or in a Network through the Internet 16. The GUI 20 is generated by a GUI code as part of the operating system (O/S) of the host processor 12. A MATLAB® environment can be hosted in the host processor 12. A user can communicate with the MATLAB® environment through GUI 20, in which the MATLAB® environment can be displayed.

In operation, upon receiving an input from the GUI 20, the host processor 12 translates the input into a computer command to cause the host processor 12 to execute a predetermined action responsive to the computer command. The predetermined action can be a step or steps of processing data according to the programs of present invention, programs of the MATLAB® environment, and/or programs as part of the operating system (O/S) of the host processor 12. All or part of the programs can be resident in a memory of the host computer 8, in a separate memory, in a CD, in a diskette, or in a memory device coupled to the host computer 8 through a network such as the Internet 16 that can be accessed and downloaded. The translation may be done in one of several ways. For example, the host processor 12 could employ a look-up table resident in memory to generate a computer command. Similarly, the computer commands could be hard wired in the host processor 12 or they could be resident in firmware. The computer commands are data or instructions in digital form, which are readable to the host processor 12. Unless the context clearly dictates otherwise, as used in the description herein and throughout the claims that follow, the meaning of “data” includes any information in digital form that is received by, originated at, saved in, related to, or exchanged by the computer 8.

Statistical Variables

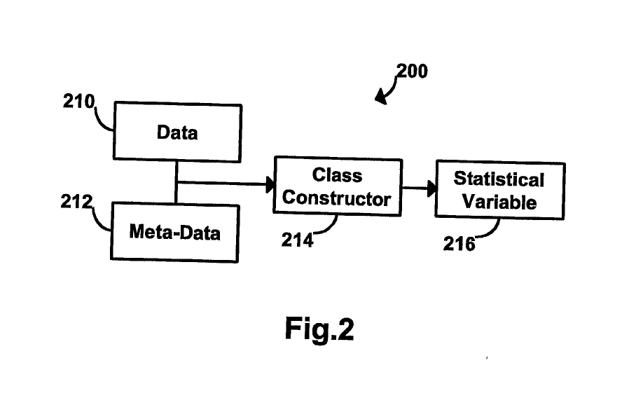

According to one embodiment of the present invention, a statistical variable embeds input data and associated meta-data, which are data describing the input data, in a single object. FIG. 2 illustrates a process 200 for processing data in a MATLAB® environment of a computer according to the present invention. At steps 210 and 212, respectively, input data and associated meta-data, which are data describing the input data, are embedded together. At step 214, the embedded input data and associated meta-data are constructed into a plurality of statistical variables, wherein the plurality of statistical variables can be processed statistically. Step 214 can be performed by a class constructor, i.e., a set of programs according to the present invention, which can perform class-specific methods. At step 216, statistical variables are generated and can be further manipulated. As an example, the following is a code for the continuous variable class constructor according to one embodiment of the present invention:

function v = continuous(varargin)
% CONTINUOUS variable class constructor
% v = continuous(data,fullname,reference_value) creates a continuous variable object
% from input data and metadata
% NOTES: Constructor must assign fields to structure in same order no matter how
the

| | |
|---|---|
| % | constructor is called. |
| % | Constructor must handle three cases: |

| | |
|---|---|
| % | - null input arguments; |
| % | - input is already of class continuous; |
| % | - non-trivial instantiation with 1, 2, or 3 input arguments. |

switch length(varargin)
case 0
case 1

data = varargin {1};

case 2

data = varargin {1};
fullname = varargin {2};

case 3

data = varargin {1};
fullname = varargin {2};
reference_value = varargin {3};

otherwise

error(‘Too many inputs.’)

end
if nargin==0

v = nullv;
v = class(v,‘continuous’);
return;

end
if isa(data,‘continuous’)

switch nargin
case 1

v = data;

case 2

v = continuous(data.data, fullname, data.reference_value);

case 3

v = continuous(data.data, fullname, reference_value);

end
return;

end
if nargin==1 | nargin==2 | nargin==3

% data must be a scalar or vector
if ndims(data)>2

v = nullv;
v = class(v,‘continuous’);
error([‘Input data has dimension ’ num2str(ndims) ’, must be a row or column

vector.’]);

end

% data must be numeric
if ˜(isnumeric(data) & isreal(data));

v = nullv;
v = class(v,‘continuous’);
error([‘Input data must be numeric.’]);

end
if issparse(data)

data = full(data);

end
v.data = data(:);
if nargin==1

% try to name input if inputname(1) is not empty
% (will be empty for expression such as “z.a” or “randn(100,1)”
v.fullname = inputname(1);
if isempty(v.fullname)

if length(v.data)==1

v.fullname = num2str(v.data);

else

v.fullname = ‘A Continuous Variable’;

end

end

else

% fullname must be a string
if isstr(fullname)

v.fullname = fullname;

else

error(‘fullname must be a string.’);

end

end
v.nmiss = sum(isnan(data));

end
% reference_value
if nargin==1 | nargin==2

v.reference_value = [NaN];

else

% must be a non-missing real numeric scalar
if length(reference_value)==1 & ...

isreal(reference_value) & isnumeric(reference_value)

v.reference_value = reference_value;

else

v.reference_value = [NaN];

end

end
% instantiate
v = class(v,‘continuous’);
superiorto(‘double’,‘categorical’);
function v = nullv;
v.data= [];
v.fullname = “;
v.nmiss = NaN;
% NaN is missing code - easier to generalize to compound variables

v.reference_value = [NaN];

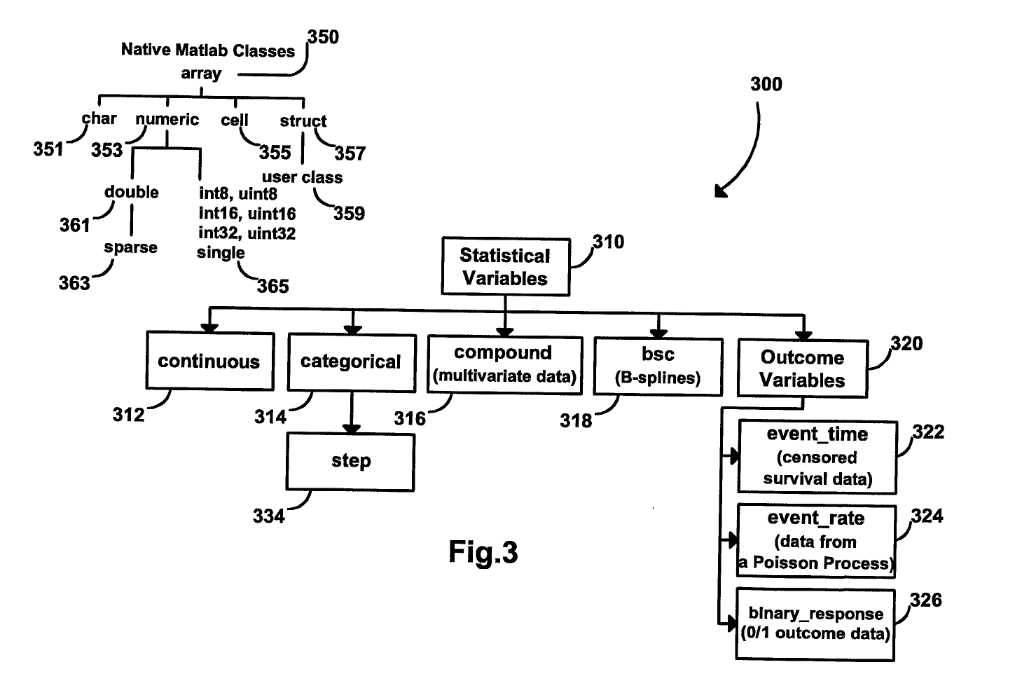

Referring now to FIG. 3, statistical variables generated according to the present invention can form a coherent structure 300. Structure 300 of statistical variables includes continuous variables 312, categorical variables 314, compound or multivariate data 316, B-spline or bsc data 318, and outcome variables 320. Many types of statistical variables can be further classified into other type or types of statistical variables. For example, categorical variables 314 can further have step variables 334, and outcome variables 320 can have censored survival data or event_time 322, data from a Poisson process or event_rate 324, 0/1 outcome data or binary response data 326. Structure 300 of statistical variables is expandable. For example, it can be expanded to include logical data (not shown), time series and longitudinal data (not shown), and/or string data (not shown).

Each type or class of statistical variables in structure 300 includes a plurality of defined object methods as detailed in Table 1. Each defined object method can be a mathematical function, logical function, or any customized function. For example, continuous variables 312, as shown in Table 1, include 34 defined object methods that define ordinary mathematical functions, logical functions, or any customized functions known to people skilled in the art. For instance, defined object method “EQ” defines a mathematical function “equal.” As an example, the following is a code for the defined object method “EQ” according to one embodiment of the present invention:

function b = eq(input_arg_v,input_arg_w);
% CONTINUOUS/EQ (EQUAL TO, ==) method for continuous variables
% The continuous/EQ method is dispatched to equate the elements of two continuous
variables,
% the elements of a continuous variable with a numeric scalar, or the elements
% of a continuous variable with a numeric double array. In the former and latter case,
% the variables must have the same length; in the latter case the numeric double array
% is coerced to class continuous before the comparison is made.
% The continuous/EQ method returns a NaN-preserving boolean statlab variable with
% cases equal to 1 if corresponding cases are equal, 0 if corresponding
% cases are not equal, and NaN (missing) if either or both of a pair of corresponding
% cases are NaN (missing).
% coerce both arguments to class continuous
v = continuous(input_arg_v);
w = continuous(input_arg_w);
if (isempty(v)) & (˜isempty(w))

b = boolean([], [‘(==‘ w.fullname’)’]);
return;

elseif (isempty(w)) & (˜isempty(v))

b = boolean([], [‘(‘v.fullname’ == )’]);
return;

elseif (isempty(v)) & (isempty(w))

b = boolean;
return;

end;
vdat = get(v,‘data’);
lvdat = length(vdat);
wdat = get(w,‘data’);
lwdat = length(wdat);
% lengths must be the same, or one length must be 1; determine case
cl = 1*(lvdat==lwdat) + 2*(lvdat==1 & lwdat>1) + 3*(lvdat>1 & lwdat==1) + ...

4*((lvdat>1 & lwdat>1) & (lvdat˜=lwdat));

switch cl
case 1

% data vectors are the same length, or one is a scalar - proceed
namev = get(v,‘fullname’);
namew = get(w,‘fullname’);
nameo [‘(‘ namev ‘==’ namew ’)’];
b = boolean(vdat == wdat, nameo);
% crucial to reset existing NaN's
b(isnan(vdat) | isnan(wdat)) = NaN;

case 2

% first input is a scalar - proceed
namew = get(w,‘fullname’);
nameo = [‘(‘ num2str(input_arg_v) ‘==’ namew ’)’];
b = boolean(vdat == wdat, nameo);
% crucial to reset existing NaN's
b(isnan(vdat) | isnan(wdat)) = NaN;

case 3

% second input is a scalar - proceed
namev = get(v,‘fullname’);
nameo = [‘(‘ namev ‘==’ num2str(input_arg_v) ’)’];
b = boolean(vdat == wdat, nameo);
% crucial to reset existing NaN's
b(isnan(vdat) | isnan(wdat)) = NaN;

case 4

% length mismatch
error([‘continuous variables must have the same length.’]);

otherwise
end

Additionally, each type or class of statistical variables in structure 300 can be expanded to include more defined object methods. Other statistical variables such as rates, proportions can also be introduced. In comparison, as shown in FIG. 3, current MATLAB® environment only provides an array of limit number native classes of data such as character 351, numeric 353, cell 355, and structure 357, where structure 357 includes user class 359, and numeric 353 includes double 361 and sparse 363, int8, unit8, . . . , single 365, which are normally not expandable.

TABLE 1

| continuous | categorical | Step | compound | bsc | event_time | event_rate | binary_response |
|---|---|---|---|---|---|---|---|
| EQ | EQ | setfield | asdataset | bsc | display | display | binary_response |
| GE | GE | squeeze | colon | display | end | end | display |
| GT | GT | step | compound | horzcat | event_time | event_rate | end |
| LE | LE | subsasgn | display | size | horzcat | horzcat | horzcat |
| LT | LT | subsref | end | subsasgn | isempty | isempty | isempty |
| NE | NE | | horzcat | subsref | isnan | isnan | isnan |
| abs | categorical | | isempty | | length | length | length |
| colon | colon | | length | | setfield | mrdivide | setfield |
| continuous | display | | mtimes | | size | setfield | size |
| cos | end | | set | | subsasgn | size | subsasgn |
| display | get | | setfield | | subsref | subsasgn | subsref |
| end | horzcat | | size | | tabulate | subsref | |
| exp | isempty | | subsasgn | | | | |
| horzcat | isnan | | subsref | | | | |
| isempty | length | | type | | | | |
| isnan | mtimes | | vertcat | | | | |
| length | set | | | | | | |
| log | setfield | | | | | | |
| log10 | size | | | | | | |
| mean | squeeze | | | | | | |
| minus | subsasgn | | | | | | |
| mpower | subsref | | | | | | |
| mrdivide | | | | | | | |
| mtimes | | | | | | | |
| plus | | | | | | | |
| set | | | | | | | |
| setfield | | | | | | | |
| sin | | | | | | | |
| size | | | | | | | |
| sqrt | | | | | | | |
| subsasgn | | | | | | | |
| subsref | | | | | | | |
| uminus | | | | | | | |
| vertcat | | | | | | | |

The availability of the plurality of statistical variables according to the present invention allows a user to process data statistically by using standard MATLAB® command syntax. However, while standard MATLAB® command syntax is used, the results of inputting MATLAB® commands and operators are tailored to the type of statistical data that are processed. In other words, in the present invention, the outcome of a predetermined computer action responsive to a standard MATLAB® command depends on the type or class of the statistical variable representing the data that are processed.

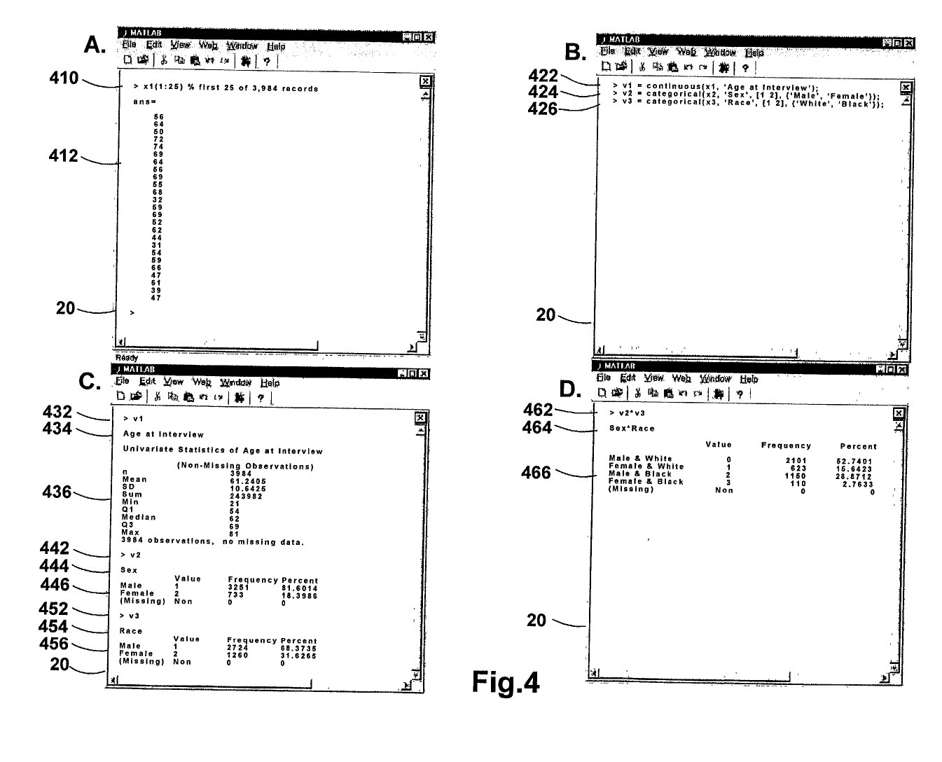

FIG. 4 illustrates such a process of processing data statistically by using statistical variables and standard MATLAB® command syntax in one embodiment of the invention. Assume a medical interview is conducted in a group containing 3,984 subjects (i.e., people), and x1 represents the age, x2 represents the sex with value 1 if a subject is a male, or 2 if a subject is a female, and x3 represents the race with value 1 if a subject is white, or 2 if a subject is black, of the group of subjects at the interview, respectively. Each interview of a subject produces one case having a group of data (x1, x2, x3). For example, a 55 year old black male at the interview would produce a group of data (55, 1, 2). If the data for x1, x2 and x3 are stored as MATLAB® numeric arrays with the same names (i.e., x1, x2, or x3), typing the name of each variable, say x1, at the MATLAB® command prompt 410, results a listing 412 of the numeric data on a user's GUI 20, as shown in FIG. 4(A). This display usually may overwhelm a user unless the number of cases is small. For this reason, the listing 412 only lists first 25 numbers of 3,984 available records. Moreover, the listing 412 does not give a user meaningful insights except a list of numbers.

In contrast, according to one embodiment of the invention and referring to FIG. 4(B), data (x1, x2, x3) can be converted into statistical variables (v1, v2, v3) as follows:

v1=continuous (x1, ‘Age at Interview’);

v2 =categorical (x2, ‘Sex’, [1 2], {‘Male’, ‘Female’}); and

v3 =categorical (x3, ‘Race’, [1 2], {‘White’, ‘Black’}),

which can be entered at the MATLAB® command prompt 422, 424 and 426, respectively. As defined, v1 represents a continuous type of statistical variable that is constructed from data x1 by using defined object method “continuous” as listed in Table 1, column 1, in a process represented in FIG. 2 and discussed above. Similarly, v2 represents a categorical type of statistical variable that is constructed from data x2 by using defined object method “categorical” as listed in Table 1, column 2, in a process represented in FIG. 2 and discussed above. Likewise, v3 represents a categorical type of statistical variable that is constructed from data x3 by using defined object method “categorical” as listed in Table 1, column 2, in a process represented in FIG. 2 and discussed above. Moreover, as given above, each of statistical variables v1, v2 and v3 has an expression giving related information. For instance, for v2=categorical (x2, ‘Sex’, [1 2], {‘Male’, ‘Female’}), “categorical ( )” represents an operator to transfer data to a statistical variable categorical, the first column inside the bracket represents data to be transferred, namely “x2”, the second column describes data in the first column, namely “Sex” indicating that “x2” are data for sex of the subjects, the third column gives value, if applicable, for the second column, and the fourth column further describes meaning of the value of the third column. Moreover, in this example, “[1 2]” at the third column indicates that sex of the subjects can take either value “1” or value “2”, and “{‘Male’, ‘Female’}” at the fourth column indicates that if the sex of a subject takes value “1”, the subject is a male, and if the sex of a subject takes value “2”, the subject is female.

Still referring to FIG. 4(B), once commands for defining statistical variables (v1, v2, v3) are entered at the MATLAB® command prompt 422, 424 and 426, respectively, data (x1, x2, x3) are stored in a memory associated with the host computer 8 as statistical variables (v1, v2, v3) as discussed above. Now typing the name of each statistical variables will give a result in a form of statistically coherent summary. As shown in FIG. 4(C), typing v1 at the MATLAB® command prompt 432 results a summary with a title “Age at Interview” 434 and a content 436 on a user's GUI 20, which gives statistically meaningful information about the subjects at the interview. For example, from content 436, one can know that there are 3,984 people at the interview with a mean age of 61.24 (years old) and median age of 62 (years old). Similarly, typing v2 at the MATLAB® command prompt 442 results a summary with a title “Sex” 444 and a content 446 on the user's GUI 20, which shows among 3,984 people at the interview, 81.6% of them or 3,251 people are male, and 18.4% of them or 733 are female. Likewise, typing v3 at the MATLAB® command prompt 452 results a summary with a title “Race” 454 and a content 456 on the user's GUI 20, which shows among 3,984 people at the interview, 68.37% of them or 2,724 people are white, and 31.63% of them or 1,260 are black.

Additionally, in one embodiment of the present invention, product of at least two of the plurality of statistical variables can produce a new statistical variable. For example, the data for x1, x2 and x3 are stored as MATLAB® numeric arrays with the same names (i.e., x1, x2, or x3), calculating x2*×3, the product of x2 and x3, has no statistical meaning. However, referring now to FIG. 4(D), if the data (x1, x2, x3) are stored as statistical variables (v1, v2, v3) as shown in FIG. 4(B) and discussed above, typing v2*v3 at the MATLAB® command prompt 462 results a new statistical variable of the categorical type (i.e. “v2*v3”) that codes for the intersection (cross) of the categories in v2 and v3 with a title “Sex*Race” 464 and a content 466 on the user's GUI 20, which shows among 3,984 people at the interview, 52.74% of them or 2101 people are male and white, 15.64% of them or 15.64 people are female and white, 28.87% of them or 1150 people are male and black, and 2.76% of them or 110 people are female and black. Thus, the present invention is capable of helping a MATLAB® user to process statistical data using standard statistical conventions (e.g., “*” means cross) and obtain a coherent summary of the data entirely within the MATLAB® environment.

Statistical Tables

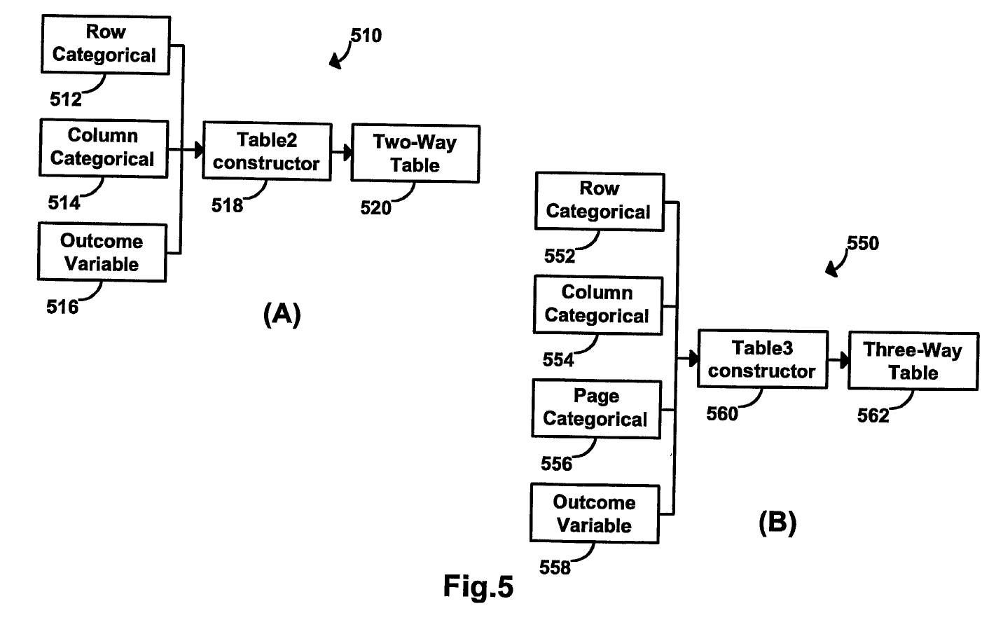

Contingency tables are a standard way of presenting and summarizing statistical data. The present invention provides programs or constructors that can create a contingency table from statistical variables. In one embodiment of the present invention, as shown in FIG. 5, there is a process 510 or 550 of creating a contingency table from the plurality of statistical variables including categorical variables. The contingency table normally is an n-way table, where n is an integer greater than 1 and represents the number of input categorical variables. For example, a two-way table is a table having two types of input categorical variables, and a three-way table is a table having three types of input categorical variables. Furthermore, the contingency table includes a plurality of cells, wherein each cell may have contents. The contents of the cells for a contingency table can vary according to the class of the outcome variable that is being summarized.

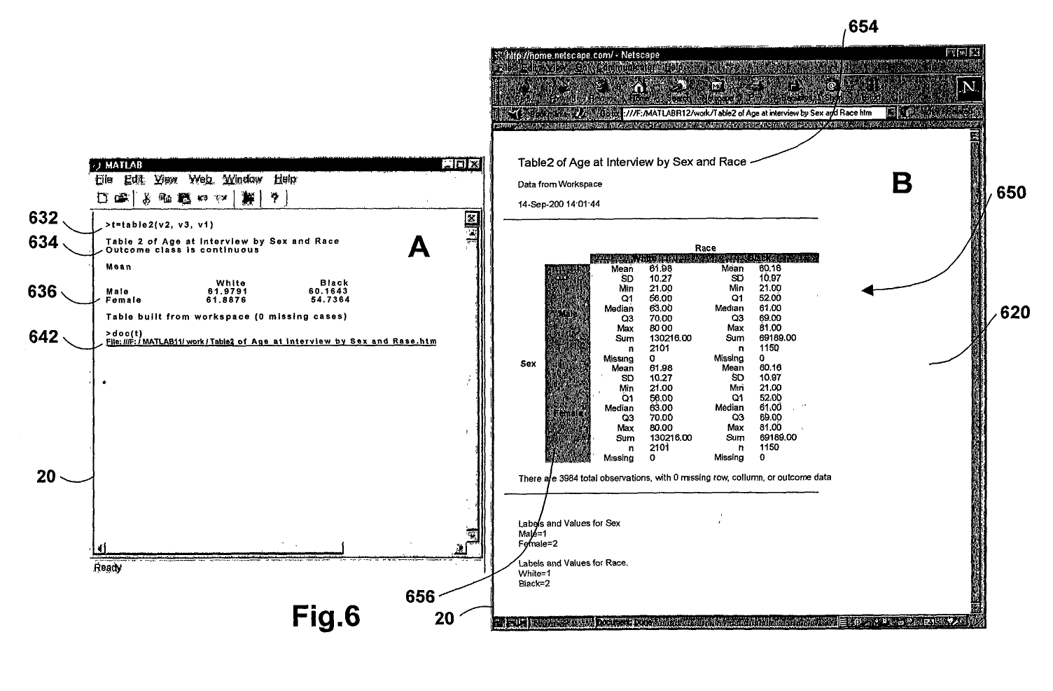

In particular, as shown in FIG. 5(A), a Table2 constructor 518 creates a two-way table 520 from two types of input categorical variables including row categorical variable 512 and column categorical variable 514. The two-way table 520 is in tabular form and presents summary statistics for outcome variable 516, where the Table2 constructor 518 embeds the input variables, i.e., row categorical variable 512, column categorical variable 514, and outcome variable 516 and the derived summary statistics into a single object. The summary statistics that are calculated are the appropriate ones for the class of the outcome variable 516. For example, referring now to FIG. 6(A), a Table2 constructor

t=table2(v2,v3,v1) can be entered at the MATLAB® command prompt 632 that results a two-way table with a title “Table2 of Age at Interview by Sex and Race” 634 and a content 636 on a user's GUI 20. Here v2 (“sex”) is the row categorical variable 512, v3 (“race”) is the column categorical variable 514, and v1 (“age”) is the outcome variable 516 (only object method “mean” from Table 1 being shown). Content 636 gives statistically meaningful information about the subjects at the interview. For example, from content 636, one can know that the mean age for white male subjects at the interview is 61.9791 (years old), the mean age for black male subjects at the interview is 60.1643 (years old), the mean age for white female subjects at the interview is 61.8876 (years old), and the mean age for black female subjects at the interview is 54.7364 (years old).

Likewise, as shown in FIG. 5(B), a Table3 constructor 560 creates a three-way table 562 from three types of input variables including row categorical variable 552, column categorical variable 554, and page categorical variable 556. The three-way table 562 is in tabular form and presents summary statistics for outcome variable 558, where the Table3 constructor 560 embeds the input variables, i.e., row categorical variable 552, column categorical variable 554, page categorical variable 556, outcome variable 558 and the derived summary statistics into a single object. The summary statistics that are calculated are the appropriate ones for the class of the outcome variable 558.

Additionally, in one embodiment of the present invention, a representation of the contingency table can be created by the hypertext markup language (“HTML”), wherein the contingency table created by using the hypertext markup language can be generated on a web page. Referring now to FIGS. 6(A) and 6(B), a MATLB® command doc(t) can be entered at the MATLAB® command prompt 642 that creates a web page 620 called

File:///F:/MATLAB11/work/Table2 of Age at Interview by Sex and Race.htm on the GUI 20 on-the-fly. The web page 620 includes a two-way table 650 with a title “Table2 of Age at Interview by Sex and Race” 654 and a content 656 from which statistically meaningful information about the subjects at the interview can be drawn. The web page 620 can be transferred, accessed and processed over the Internet 16.

Each statistical table of the present invention can include a plurality of defined object methods as detailed in Table 2. In Table 2, for the purpose of exemplary only, contingency table constructors Table2 and Table3 are listed, each containing a number of defined methods. As discussed above, each defined object method can be a mathematical function, logical function, or any customized function. For example, contingency tale constructor Table2, as shown in Table 2, includes 12 defined object methods that define ordinary mathematical functions, logical functions, or some customized functions. For instance, defined object method “size” defines a customized function that lists the number of cases in the input data, the number of rows in the derived contingency table, and the number of columns in the derived contingency table.

Statistical Datasets

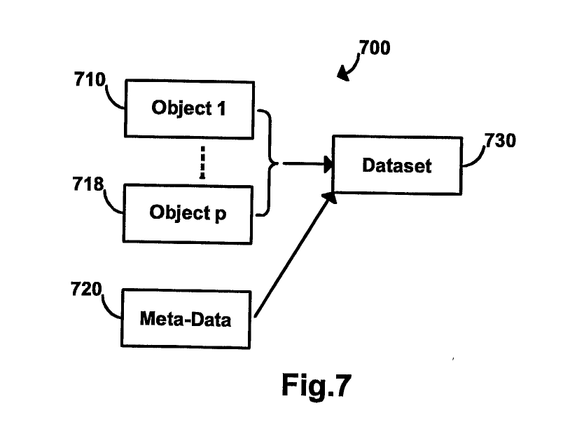

In another aspect of the present invention, statistical variables can be aggregated into statistical datasets. Referring now to FIG. 7, there is shown a process 700 of aggregating a dataset in one embodiment of the present invention. A plurality 710 of object 1, object 2 . . . object p with same length, where p is an integer, and associated meta-data 720 is aggregated into a dataset 730. As used in the specification, “length” is defined as the number of cases contained in the data for an object. For example, for the object v1 as shown in FIG. 4(c), the length v1 is 3,984. Dataset 730 can be an arbitrary aggregation of objects 710 and meta-data 720. Each of the objects 710 can be a data array such as a two-dimensional rectangular numeric array of data, a class or type of statistical variables, a statistical model (as defined infra), and/or a combination of them.

TABLE 2

| Dataset | table2 | table3 |
|---|---|---|
| dataset | asdataset | asdataset |
| display | ctranspose | display |
| doc | display | doc |
| drop | doc | end |
| end | end | isempty |
| isempty | isempty | length |
| length | length | permute |
| put | size | size |
| rmfield | subsasgn | subsasgn |
| setfield | subsref | subsref |
| size | table2 | table3 |
| subsasgn | transpose | |
| subsref | | |
| tabulate | | |
| type | | |

A plurality of defined object methods as detailed in Table 2 can be operated on each dataset. As discussed above, each defined object method can be a mathematical function, a logical function, or a customized function. As shown in Table 2, column 1, there are 15 defined object methods that define ordinary mathematical functions, logical functions, or some customized functions and can be operated on dataset. For instance, defined object method “subsasgn” defines a case selection method known to people skilled in the art, can operate on all of the variables within the dataset at once. For example, if d is a dataset object containing statistical variables v1, v2 and v3 as shown in FIG. 4(B) and discussed above, the MATLAB® command dm=d (d.v2==1) will create a new dataset dm containing instances of the statistical variables v1, v2 and v3 but with data restricted to those cases whose v2 (“sex”) has value “1” (male), e.g., dm will be a dataset containing instances of male only. Thus, the availability of dataset in the present invention allows a user to manipulate arbitrarily complex collections of statistical variables entirely within the MATLAB® environment using methods that previously were available only within specialized statistical packages. This capability allows a MATLAB® user to tackle large-scale data analysis problems efficiently within the MATLAB® environment.

Statistical Models

In a further aspect of the present invention, a plurality of statistical models using object-oriented paradigms are implemented. One of the most widely used class of statistical models is the class of generalized linear models. Additionally, the proportional hazards regression model for censored survival data is another one of the most widely used classes of regression models in medical outcomes research. Both have been implemented in the present invention by an object-oriented paradigm. Additional models can also be implemented.

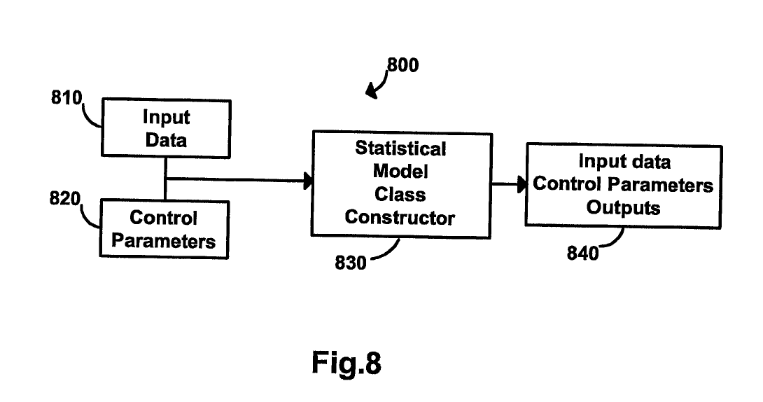

As shown in FIG. 8, a general paradigm 800 of implementing a statistical model in one embodiment of the invention is provided. A statistical model constructor 830 or a set of programs embeds input data 810 for the statistical model, control parameters 820, and the output of the model into a single object 840. The input data 810 can be processed using the control parameters 820 to produce an output according to the statistical model.

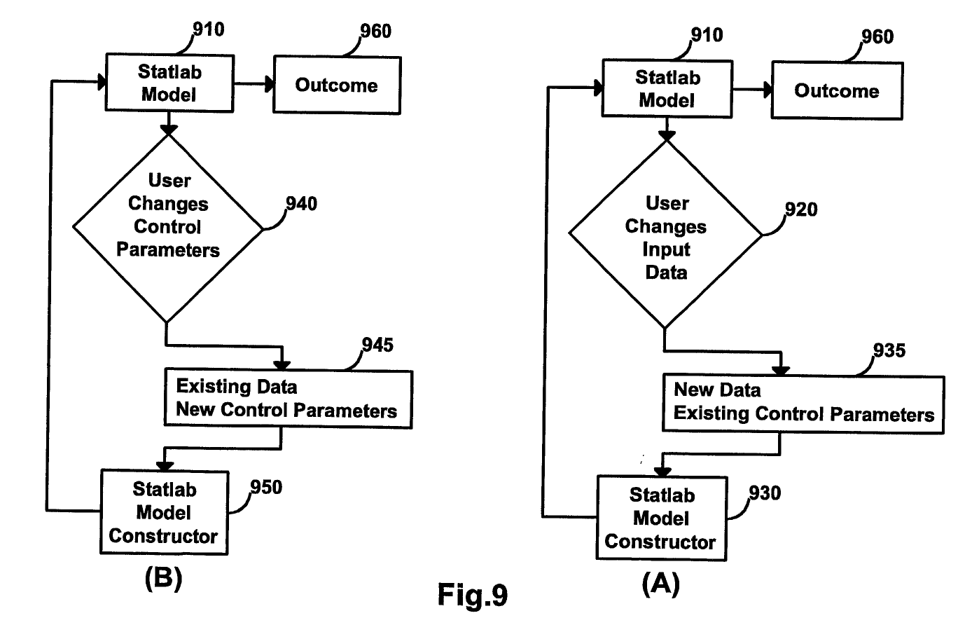

In one embodiment of the present invention, the input data are adjustable. When the input data are adjusted, the output is changed accordingly. As shown in FIG. 9(A), at step 910, a statistical model is selected to process input data. At step 920, a user adjusts the input data using MATLAB® command. At step 935, new input data are provided through, for example, GUI 20. At step 930, statistical model constructor embeds the adjusted input data, existing control parameters, and the output into a single object, which is then processed at step 910 according to the model. The outcome 960 of the model can be displayed and processed using MATLAB® commands such as displayed on GUI 20, printed at printer 10, saved in a memory (not shown), or transmitted over the Internet 16.

In another embodiment of the present invention, the control parameters are adjustable. When the control parameters are adjusted, the output is changed accordingly. As shown in FIG. 9(B), at step 910, a statistical model is selected to process input data. The statistical model has its default or existing control parameters. At step 940, a user adjusts the control parameters. At step 945, new control parameters are input through, for example, GUI 20. At step 950, statistical model constructor 950 embeds the input data, new control parameters, and the output into a single object, which is then processed at step 910 according to the model and the new control parameters. The output 960 can be displayed on GUI 20, printed out at printer 10, saved in a memory (not shown), or transmitted over the Internet 16.

Thus, according to the present invention, if a user changes either the input data or the control parameters the results are updated automatically. The updated results reflecting changes in the output can be viewed and documented interactively through a MATLAB® based GUI 20. Moreover, adjusting the input data or control parameters can be performed by adjusting the input data or interactively through a MATLAB® based graphical interface. This invention makes it much easier for the user to carry out interactive modeling, subset analysis, and sensitivity analyses, tasks which are almost always required as part of large scale projects.

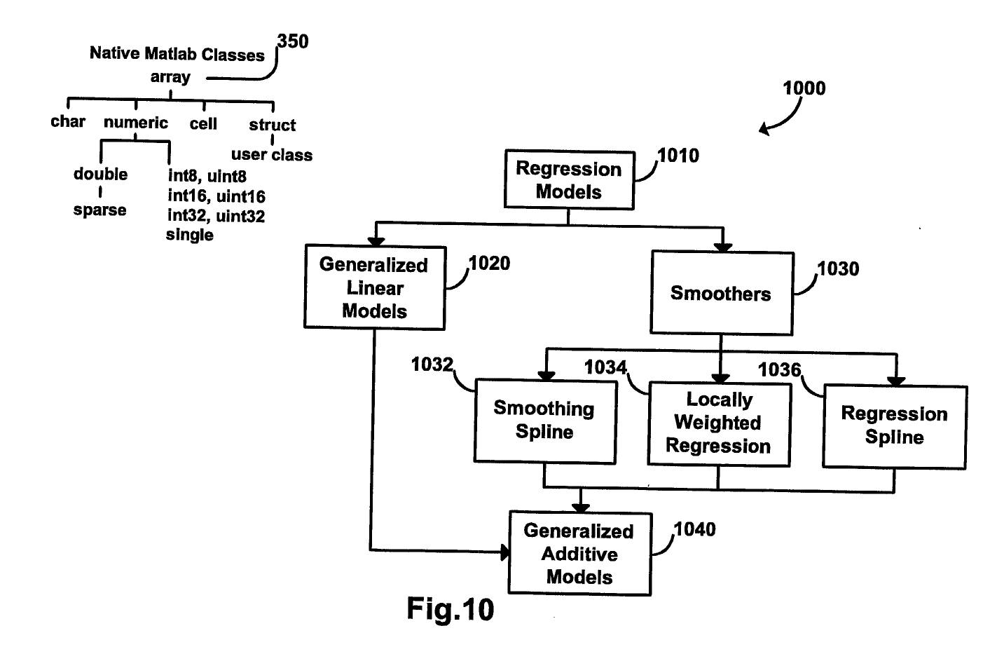

Referring now to FIG. 10, where classes of regression models 1010 employed in one of the invention are shown. The regression models 1010 can be divided into several classes such as generalized linear models 1020, generalized additive models 1040, proportional hazards regression models (not shown), or a smoother 1030. Each class of regression models can be further divided into several sub-classes. For example, smoother 1030 can include smoothing spline model 1032, locally weighted regression model 1034, and regression spline model 1036.

Each class of regression models of the present invention can include a plurality of defined object methods as detailed in Table 3. In Table 3, which is shown for the purpose of exemplary only, generalized linear model, smoothing spline model, locally weighted regression model, and regression model are listed, each containing a number of defined methods that are arranged alphabetically. As discussed above, each defined object method can be a mathematical function, logical function, or any customized function. For example, generalized linear model (“glm”), as shown in Table 3, include 10 defined object methods that define ordinary mathematical functions, logical functions, or some customized functions. For instance, defined object method “subsref” defines a customized function that allows a user to examine any of the properties of the model, including the input data, the control parameters of a model, and all of the outputs of the models. Moreover, many object methods in the present invention can define same functionality across the various aspects of the present invention. For example, defined object method “size” defines a customized function of the dimensions of the embedded statistical data in an object, no matter the defined object method “size” is associated with a statistical dataset, a statistical table or a statistical model.

TABLE 3

| | | loess1 - | |
|---|---|---|---|
| glm - generalized | Ss1 - smoothing | locally weighted | rs1 - regression |
| linear models | spline | regression | spline |
| display | cp | cp | cp |
| doc | display | display | display |
| end | doc | doc | doc |
| gim | gcv | gcv | gcv |
| length | interpl | interpl | interpl |
| line | isempty | isempty | isempty |
| plot | length | length | length |
| size | line | line | line |
| subsasgn | min | loess1 | min |
| subsref | plot | min | plot |
| | size | plot | rs1 |
| | ss1 | size | size |
| | subsasgn | subsasgn | subsasgn |
| | subsref | subsref | subsref |

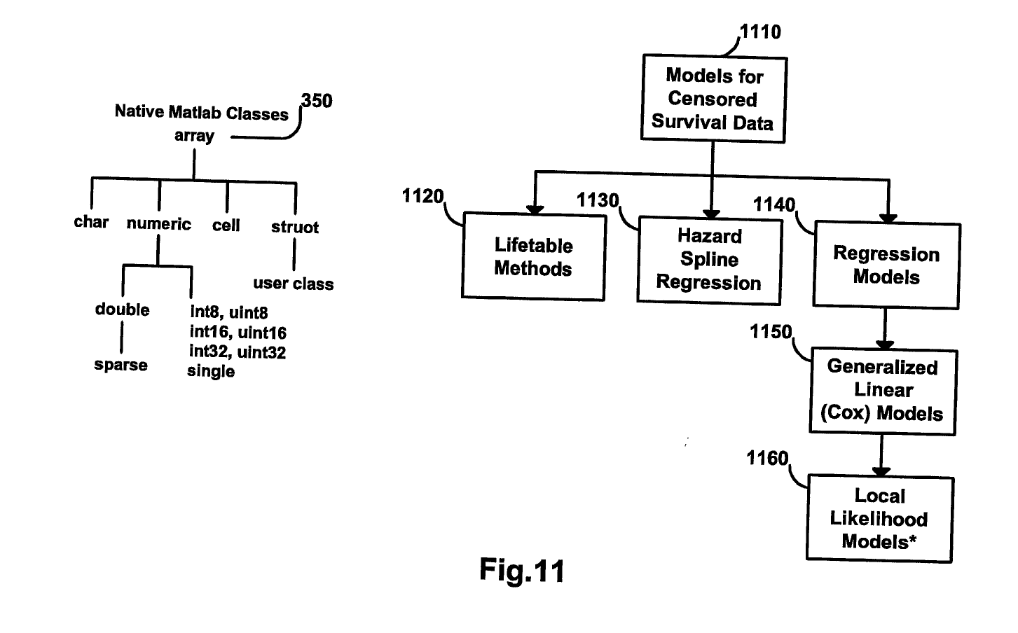

Likewise, classes of models 1110 for censored survival data employed in one embodiment of the invention are shown in FIG. 11. The models 1110 for censored survival data can be divided into several classes such as lifetable methods model 1120, hazard spline regression model 1130, or regression models 1140. Each class of models 1110 for censored survival data may be further divided into several sub-classes. For example, regression models 1140 can include generalized linear (Cox) models 1150, and local likelihood models 1160.

TABLE 4

| | hsp-hazard | phreg - proportional hazards | phgam - local |
|---|---|---|---|
| Lifetable | spline | regression model | likelihood models |
| display | aic | display | phgam |
| doc | display | doc | |
| end | doc | end | |
| lifetable | end | line | |
| line | hsp | phreg | |
| plot | line | plot | |
| setfield | min | size | |
| size | plot | subsasgn | |
| subsasgn | setfield | subsref | |
| subsref | size | | |
| | subsasgn | | |
| | subsref | | |

Each class of models 1110 for censored survival data may include a plurality of defined object methods as detailed in Table 4. In Table 4, which is shown for the purpose of exemplary only, lifetable model, hazard spline (“hsp”) model, proportional hazards regression (“phreg”) model, and local likelihood (“phgam”) model are listed, each containing a number of defined methods that are arranged alphabetically. As discussed above, each defined object method can be a mathematical function, logical function, or any customized function. For example, lifetable model, as shown in Table 4, include 10 defined object methods that define ordinary mathematical functions, logical functions, or some customized functions. For instance, defined object method “subsref” defines a customized function of allowing a user to extract all the component calculations that constitute a lifetable.

Each class of models has methods that produce numeric summaries of the results using HTML and graphical summaries using a variety of universally supported graphics file formats. The classes of smoothers, and the hazard spline regression method for censored survival data, each may have a MATLAB-based graphical user interface, such as GUI 20, that allows a user to interactively vary the control parameters of the respective models and observe and document the resulting changes in the output.

The present invention further includes a computer program product in a computer readable medium of instructions. The computer program product has instructions within the computer readable medium for embedding input data and associated meta-data in a single object, and instructions within the computer readable medium for constructing the input data and associated meta-data into a plurality of statistical variables, wherein the plurality of statistical variables can be processed statistically. Additionally, the computer program product has the instructions within the computer readable medium for generating the plurality of statistical variables including continuous variables, categorical variables, rates, proportions, compound data, B-spline data, censored survival data, data from a Poisson process, binary response data, logical data, and longitudinal data. Moreover, the computer program product of the present invention has instructions within the computer readable medium for producing a new statistical variable by a product of at least two of the plurality of statistical variables.

Additionally, the computer program product has instructions within the computer readable medium for creating a contingency table from the plurality of statistical variables. Furthermore, the computer program product has the instructions within the computer readable medium for creating a contingency table from the plurality of statistical variables written in the hypertext markup language, wherein the contingency table can be generated on a web page.

Moreover, the computer program product has instructions within the computer readable medium for aggregating a dataset from the plurality of statistical variables and instructions within the computer readable medium for processing all statistical variables in the dataset at once using standard MATLAB® syntax.

In yet another aspect, the present invention includes a computer program product in a computer readable medium of instructions for processing data in a MATLAB® environment of a computer. The computer program product has instructions within the computer readable medium for providing a statistical model with control parameters, instructions within the computer readable medium for receiving and providing input data, instructions within the computer readable medium for constructing the input data and the control parameters into a single object, and instructions within the computer readable medium for processing the input data in the single object to produce an output according to the model.

In one embodiment of the present invention, the computer program product has instructions within the computer readable medium for adjusting the input data, wherein when the input data are adjusted, the output is changed accordingly. Moreover, the computer program product has instructions within the computer readable medium for viewing and documenting the changes in the output interactively through a MATLAB® based graphical interface. Additionally, the computer program product has instructions within the computer readable medium for adjusting the input data interactively through a MATLAB® based graphical interface.

In another embodiment of the present invention, the computer program product has instructions within the computer readable medium for adjusting control parameters, wherein when the control parameters are adjusted, the output is changed accordingly. Moreover, the computer program product has instructions within the computer readable medium for adjusting control parameters interactively through a MATLAB® based graphical interface.

In a further aspect, the present invention relates to a system for managing data in a MATLAB® environment of a computer. The system has a processing means for embedding input data and associated meta-data in a single object, and an operating means for constructing the input data and associated meta-data into a plurality of statistical variables, wherein the plurality of statistical variables can be processed statistically. In one embodiment of the present invention, the processing means can be a host processor associated with the computer, and the operating means can be an operating system resident in a memory of the computer.

In yet another aspect, the present invention relates to a system for managing data in a MATLAB® environment of a computer. The system has means for providing a statistical model with control parameters, means for providing input data, means for constructing the input data and the control parameters into a single object, and means for processing the input data in the single object to produce an output according to the model. In one embodiment of the present invention, where the input data are adjustable, and the system has means for changing the output accordingly when the input data are adjusted. Moreover, the system further includes means for viewing and documenting the changes in the output interactively through a MATLAB® based graphical interface, and means for adjusting the input data interactively through a MATLAB® based graphical interface. In another embodiment of the present invention, where the control parameters are adjustable, and the system has means for changing the output accordingly when the set of control parameters are adjusted. Moreover, the system further has means for adjusting the control parameters interactively through a MATLAB® based graphical interface.

Statistical variables, tables, and datasets provide the user with powerful new tools for processing and summarizing statistical data in MATLAB. Because of their object-oriented design, these new objects are integrated into the MATLAB® environment in an intuitive and natural manner and they are manipulated using standard MATLAB® syntax. Furthermore, at any point, the numerical contents of these objects can be made available to MATLAB® environment in “native” (numeric or structure array) form for subsequent analysis in MATLAB® environment. Alternatively, Statlab modes, described below, can be used to make statistical inferences about the data contained in statistical variables.

The present invention can be operated in any environment that supports MATLAB®, including Windows® or the Apple Mac®O/S.

As those skilled in the art will appreciate, while the present invention has been described in the context of a fully functional data management system, the mechanism of the present invention is capable of being distributed in the form of a computer readable medium of instructions in a variety of forms, and the present invention applies equally regardless of the particular type of signal bearing media used to actually carry out the distribution. Examples of computer readable media include: recordable type media such as floppy disks and CD-ROMs and transmission type media such as digital and analog communication links.

While there has been shown preferred and alternate embodiments of the present invention, it is to be understood that certain changes can be made in the form and arrangement of the elements of the system and steps of the method as would be know to one skilled in the art without departing from the underlying scope of the invention as is particularly set forth in the claims. Furthermore, the embodiments described above are only intended to illustrate the principles of the present invention and are not intended to limit the claims to the disclosed elements.

What is claimed is:

1. A method for processing data in a MATLAB® environment of a computer, comprising the steps of:
a. embedding input data and associated meta-data in a single object; and
b. constructing the input data and associated meta-data into a plurality of statistical variables, wherein the plurality of statistical variables can be processed statistically.

2. The method of claim 1, wherein the plurality of statistical variables form a coherent structure.

3. The method of claim 2, wherein the plurality of statistical variables include continuous variables, categorical variables, rates, proportions, compound data, B-spline data, censored survival data, data from a Poisson process, binary response data, logical data, string data and longitudinal data.

4. The method of claim 2, wherein a product of at least two of the plurality of statistical variables produces a new statistical variable.

5. The method of claim 1, further comprising a step of creating a contingency table from the plurality of statistical variables.

6. The method of claim 5, wherein the contingency table is a two-way contingency table.

7. The method of claim 5, wherein the contingency table is a three-way contingency table.

8. The method of claim 5, wherein the step of creating a contingency table from the plurality of statistical variables comprises a step of creating the contingency table using the hypertext markup language.

9. The method of claim 8, wherein the contingency table created by using the hypertext markup language is generated on a web page.

10. The method of claim 1, further comprising a step of aggregating a dataset from the plurality of statistical variables.

11. The method of claim 10, wherein the step of aggregating a dataset from the plurality of statistical variables comprises the steps of:
a. providing a plurality of objects with same length, each object having a set of statistical variables;
b. providing meta-data associated with the plurality of objects; and
c. constructing a dataset from the plurality of objects and the associated meta-data, wherein all statistical variables in the dataset can be statistically processed at once.

12. The method of claim 11, wherein all statistical variables in the dataset can be statistically processed at once using standard MATLAB® syntax.

13. A method for processing data in a MATLAB® environment of a computer, comprising the steps of:
a. providing a statistical model with control parameters;
b. providing input data;
c. constructing the input data and the control parameters into a single object; and
d. processing the input data in the single object to produce an output according to the statistical model.

14. The method of claim 13, further comprising a step of adjusting the input data.

15. The method of claim 14, when the input data are adjusted, the output is changed accordingly.

16. The method of claim 15, further comprising a step of viewing and documenting the changes in the output interactively through a MATLAB® based graphical interface.

17. The method of claim 14, wherein the step of adjusting the input data comprises a step of adjusting the input data interactively through a MATLAB® based graphical interface.

18. The method of claim 13, further comprising a step of adjusting control parameters.

19. The method of claim 18, when the control parameters are adjusted, the output is changed accordingly.

20. The method of claim 18, wherein the step of adjusting control parameters comprises a step of adjusting the control parameters interactively through a MATLAB® based graphical interface.

21. The method of claim 13, wherein the statistical model is a regression model.

22. The method of claim 21, wherein the regression model includes a generalized linear model.

23. The method of claim 21, wherein the regression model includes a generalized additive model.

24. The method of claim 21, wherein the regression model includes a proportional hazards regression model.

25. The method of claim 21, wherein the regression model includes a smoother.

26. The method of claim 13, wherein the statistical model is a model for censored survival data.

27. The method of claim 26, wherein the model for censored survival data includes a regression model.

28. The method of claim 26, wherein the model for censored survival data includes a generalized linear (Cox) model.

29. The method of claim 26, wherein the model for censored survival data includes a local likelihood model.

30. The method of claim 26, wherein the model for censored survival data includes lifetable methods.

31. The method of claim 26, wherein the model for censored survival data includes hazard spline regression.

32. A computer program product in a computer readable medium of instructions, comprising:
a. instructions within the computer readable medium for embedding input data and associated meta-data in a single object; and
b. instructions within the computer readable medium for constructing the input data and associated meta-data into a plurality of statistical variables,
wherein the plurality of statistical variables can be processed statistically.

33. The computer program product of claim 32, wherein the instructions within the computer readable medium for constructing the input data and associated meta-data into a plurality of statistical variables comprise the instructions within the computer readable medium for generating the plurality of statistical variables including continuous variables, categorical variables, rates, proportions, compound data, B-spline data, censored survival data, data from a Poisson process, binary response data, logical data, and longitudinal data.

34. The computer program product of claim 33, further comprising instructions within the computer readable medium for producing a new statistical variable by a product of at least two of the plurality of statistical variables.

35. The computer program product of claim 32, further comprising instructions within the computer readable medium for creating a contingency table from the plurality of statistical variables.

36. The computer program product of claim 35, wherein the contingency table is a two-way contingency table.

37. The computer program product of claim 35, wherein the contingency table is a three-way contingency table.

38. The computer program product of claim 35, wherein the instructions within the computer readable medium for creating a contingency table from the plurality of statistical variables comprises the instructions within the computer readable medium for creating a contingency table from the plurality of statistical variables written in the hypertext markup language.

39. The computer program product of claim 38, wherein the instructions within the computer readable medium for creating a contingency table from the plurality of statistical variables written in the hypertext markup language comprise instructions within the computer readable medium for generating the contingency table on a web page.

40. The computer program product of claim 32, further comprising instructions within the computer readable medium for aggregating a dataset from the plurality of statistical variables.

41. The computer program product of claim 40, wherein the instructions within the computer readable medium for aggregating a dataset from the plurality of statistical variables comprise instructions within the computer readable medium for processing all statistical variables in the dataset at once using standard MATLAB® syntax.

42. A computer program product in a computer readable medium of instructions for processing data in a MATLAB® environment of a computer, comprising:
a. Instructions within the computer readable medium for providing a statistical model with control parameters;
b. Instructions within the computer readable medium for receiving and providing input data;
c. Instructions within the computer readable medium for constructing the input data and the control parameters into a single object; and
d. Instructions within the computer readable medium for processing the input data in the single object to produce an output according to the model.

43. The computer program product of claim 42, further comprising instructions within the computer readable medium for adjusting the input data.

44. The computer program product of claim 43, wherein when the input data are adjusted, the output is changed accordingly.

45. The computer program product of claim 44, further comprising instructions within the computer readable medium for viewing and documenting the changes in the output interactively through a MATLAB® based graphical interface.

46. The computer program product of claim 43, further comprising instructions within the computer readable medium for adjusting the input data interactively through a MATLAB® based graphical interface.

47. The computer program product of claim 42, further comprising instructions within the computer readable medium for adjusting control parameters.

48. The computer program product of claim 47, wherein when the control parameters are adjusted, the output is changed accordingly.

49. The computer program product of claim 47, wherein the instructions within the computer readable medium for adjusting control parameters comprise instructions within the computer readable medium for adjusting control parameters interactively through a MATLAB® based graphical interface.

50. The computer program product of claim 42, wherein the statistical model is a regression model.

51. The computer program product of claim 50, wherein the regression model includes a generalized linear model.

52. The computer program product of claim 50, wherein the regression model includes a generalized additive model.

53. The computer program product of claim 50, wherein the regression model includes a proportional hazards regression model.

54. The computer program product of claim 50, wherein the regression model includes a smoother.

55. The computer program product of claim 42, wherein the statistical model is a model for censored survival data.

56. The computer program product of claim 55, wherein the model for censored survival data includes a regression model.

57. The computer program product of claim 55, wherein the model for censored survival data includes a generalized linear (Cox) model.

58. The computer program product of claim 55, wherein the model for censored survival data includes a local likelihood model.

59. The computer program product of claim 55, wherein the model for censored survival data includes lifetable methods.

60. The computer program product of claim 55, wherein the model for censored survival data includes hazard spline regression.

61. A system for processing data in a MATLAB® environment of a computer, comprising:
a. a processing means for embedding input data and associated meta-data in a single object; and
b. an operating means for constructing the input data and associated meta-data into a plurality of statistical variables,
wherein the plurality of statistical variables can be processed statistically.

62. The system of claim 61, further comprising means for creating a contingency table from the plurality of statistical variables.

63. The system of claim 62, wherein the means for creating a contingency table from the plurality of statistical variables comprises means for creating the contingency table using the hypertext markup language.

64. The system of claim 63, wherein the means for creating the contingency table using the hypertext markup language comprises means for generating the contingency table on a web page.

65. The system of claim 61, further comprising means for aggregating a dataset from the plurality of statistical variables.

66. The system of claim 61, further comprising means for processing all statistical variables in the dataset statistically at once using standard MATLAB® syntax.

67. A system for processing data in a MATLAB® environment of a computer, comprising:
a. means for providing a statistical model with control parameters;
b. means for providing input data;
c. means for constructing the input data and the control parameters into a single object; and
d. means for processing the input data in the single object to produce an output according to the statistical model.

68. The system of claim 67, wherein the input data are adjustable, and further comprising means for changing the output accordingly when the input data are adjusted.

69. The system of claim 68, further comprising means for viewing and documenting the changes in the output interactively through a MATLAB® based graphical interface.

70. The system of claim 68, further comprising means for adjusting the input data interactively through a MATLAB® based graphical interface.

71. The system of claim 67, wherein the control parameters are adjustable, and further comprising means for changing the output accordingly when the set of control parameters are adjusted.

72. The system of claim 71, further comprising means for adjusting the control parameters interactively through a MATLAB® based graphical interface.
